(19) United States
(12) Patent Application Publication
(10) Pub. No.: US 2008/0033972 A1
(43) Pub. Date: Feb. 7, 2008

(54) Common Information Model for Web Service for Management with Aspect and Dynamic Patterns for Real-Time System Management

(76) Inventors: Jianwen Yin, Round Rock, TX (US); Timothy Abels, Pfugerville, TX (US)

Correspondence Address: HAMILTON & TERRILE, LLP, P.O. BOX 203518, AUSTIN, TX, 78720, US

(21) Appl. No.: 11/462,387

(22) Filed: Aug. 4, 2006

(51) Int. Cl. G06F 7/00

(52) U.S. Cl. 707/101

(57) ABSTRACT

A system and method is disclosed for reducing the effects of cross-profile crosscutting concerns to enable just-in-time configuration updates and real-time adaptation in the Common Information Model (CIM). The CIM object model is thereby allowed to adapt to dynamic role, resource, or service changes such as logging, debugging, security or quality of service (QOS). An aspect syntactic analyzer is implemented to extend a CIM Managed Object Format (MOF) to implement aspect and dynamic pattern extensions. CIM MOF extensions comprise an Aspect Oriented Programming (AOP) join point. The join point can be implemented as an association class referencing two classes or as a method call of a first class to a property of a second class. The two classes may reside in the same or different CIM profiles. A CIM repository is accessed by a CIM Object Manager (CIMOM) comprising an aspect weaver implemented to enable AOP operations between CIM clients and data providers. The CIM providers comprise an Aspect Semantic Analyzer to similarly enable AOP operations comprising CIM MOF aspect and dynamic pattern extensions. As a result, cross-profile crosscutting concerns are reduced, thereby allowing dynamic changes in the CIM model and enabling just-in-time configuration changes and real-time environment adaptation.

### BACKGROUND OF THE INVENTION

1. Field of the Invention

The present invention relates in general to the field of information handling systems and more specifically, to systems management.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems continue to grow in power, capabilities and variety, and with the advent of the Internet, they have also become more numerous and more distributed. As a result, their management has become increasingly complex, in part due to the growing heterogeneity of the elements that comprise them and the diversity of their associated management environments. In response, the Distributed Management Task Force (DMTF) has developed frameworks that facilitate the interoperable exchange of management information between managed elements and corresponding management systems. One of these frameworks is the Common Information Model (CIM), which provides a consistent definition and structure of management information through the use of object-oriented techniques. As a conceptual information model, the CIM is structured such that managed environments can be viewed as collections of interrelated systems, each of which is comprised of a number of discrete elements.

The CIM, comprised of a specification and a schema, allows management-related information about these elements to be transparently exchanged between management systems. The specification describes an object-oriented meta model based on the Unified Modeling Language (UML) and defines how the CIM can be integrated with other management models. These include, but are not limited to, Simple Network Management Protocol (SNMP) Management Information Base (MIB) or DMTF Management Information Format (MIF). The CIM schema currently defines thousands of classes with properties, methods and associations that represent component elements such as, but not limited to, processors, firmware, sensors and fans as a common set of managed objects. The CIM schema also allows for the definition of namespaces, a directory-like structure that allows classes to be organized in a more hierarchical structure. Classes within these namespaces are served by data providers, which communicate with managed objects to access data and event notifications. These providers typically implement profiles that define the CIM model and associated behavior for a management domain comprising one or more namespaces within a CIM Object Manager (CIMOM). While this architecture facilitates the tracking and depiction of interdependencies and associations between managed objects, multi-provider implementations pose challenges for CIM management clients that consume interrelated data from multiple profiles.

For example, a CIM client is currently required to traverse though all registered profiles to determine which have profiles been implemented in each namespace and then enumerate and keep track of their associations. In addition, the client also needs to determine which central CIM class instances are associated with each of the profiles in each namespace, and then integrate all associated namespace data into a consolidated data structure representing the managed system. The situation is further complicated when different vendors implement cross-profile associations. Due to cross-cutting concerns, this approach can result in inconsistencies in data populated across different CIM management client applications, leading to interoperability, data integrity and manageability issues. Furthermore, similar issues can arise from cross-cutting concerns within the same profile as the behavior of one class is often dependent upon the properties of another class. These cross-cutting concerns extend to multiple management aspects including logical aspect, physical aspect, security aspect, capability aspect, service aspect, etc. As a result, there is a lack of support for just-in-time configuration updates and real-time environment adaptation due to the CIM object model currently being unable to adapt to dynamic role, resource, or service changes such as logging, debugging, security or quality of service (QOS). In view of the foregoing, there is a need for mitigating the effects of cross-profile crosscutting concerns to allow dynamic changes in the CIM model and enable real-time adaptation.

### SUMMARY OF THE INVENTION

In accordance with the present invention, a system and method is disclosed for reducing the effects of cross-profile crosscutting concerns to enable just-in-time configuration updates and real-time adaptation in the Common Information Model (CIM). Various embodiments of the invention allow the CIM object model to adapt to dynamic role, resource, or service changes such as logging, debugging, security or quality of service (QOS). In these embodiments, an aspect syntactic analyzer is implemented to extend a CIM Managed Object Format (MOF) to implement aspect and dynamic pattern extensions. In an embodiment of the invention, CIM MOF extensions comprise an Aspect Oriented Programming (AOP) join point familiar to those of skill in the art. In one embodiment of the invention, the join point is implemented as an association class referencing two classes. In an embodiment of the invention, the two classes may reside in different CIM profiles. In another embodiment of the invention, the two classes may reside in the same profile. In a different embodiment of the invention, the join point is implemented as a method call of a first class to a property of a second class. In an embodiment of the invention, the two classes may likewise reside in different CIM profiles or the same profile.

In various embodiments of the invention, a CIM repository is accessed by a CIM Object Manager (CIMOM) comprising a CIMOM aspect weaver, which is implemented to enable AOP operations between AOP-enabled CIM clients and CIM data providers. These CIM providers comprise a CIM Aspect Semantic Analyzer to similarly enable AOP operations comprising CIM MOF aspect and dynamic pattern extensions. As a result, cross-profile crosscutting concerns are reduced, thereby allowing dynamic changes in the CIM model and enabling just-in-time configuration changes and real-time environment adaptation. In an embodiment of the invention an AOP-enabled Web Services Management (WS-Man) client is implemented to talk to a WS-Man client application comprising an aspect semantic analyzer in its provider and an aspect weaver in its listen service.

In another embodiment of the invention, a WS-Man system is implemented to provide system management of a legacy system. In this embodiment, a managed computer comprises WS-Management client application, a management agent, and a CIM object model implementation (e.g., Windows Management Instrumentation, etc.), along with an Intelligent Platform Management Interface (IPMI) proxy. The IPMI proxy implements a proprietary protocol to couple the managed system's IPMI data provider and Baseboard Management Controller (BMC) implemented with a CIM protocol such as WMI to the legacy system. The IPMI proxy then conveys management information from the legacy system to the IPMI provider, which then provides it through WS-Man-enabled link to a WS-Management client application implemented on the management server. Those of skill in the art will understand that many such embodiments and variations of the invention are possible, including but not limited to those described hereinabove, which are by no means all inclusive.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of an information handling system 100 that can be used to implement the system and method of the present invention;

FIG. 2 is a generalized block diagram of a Common Information Model (CIM) object model implemented with aspect and dynamic pattern extensions in accordance with an embodiment of the invention;

FIG. 3 is a generalized block diagram of a Web Services Management (WM-Man) protocol stack as implemented in accordance with an embodiment of the invention, and;

FIG. 4 is a generalized block diagram of a Web Services Management (WS-Man) system as implemented with a legacy system in accordance with an embodiment of the invention.

### DETAILED DESCRIPTION

A system and method is disclosed for reducing the effects of cross-profile crosscutting concerns to enable just-in-time configuration updates and real-time adaptation in the Common Information Model (CIM). Various embodiments of the invention allow the CIM object model to adapt to dynamic role, resource, or service changes such as logging, debugging, security or quality of service (QOS). In these embodiments, an aspect syntactic analyzer is implemented to extend a CIM Managed Object Format (MOF) to implement aspect and dynamic pattern extensions. In an embodiment of the invention, CIM MOF extensions comprise an Aspect Oriented Programming (AOP) join point. In one embodiment of the invention, the join point is implemented as an association class referencing two classes. In a different embodiment of the invention, the join point is implemented as a method call of a first class to a property of a second class. In these embodiments, the two classes may reside in the same or different CIM profiles. In various embodiments of the invention, a CIM repository is accessed by a CIM Object Manager (CIMOM) comprising an aspect weaver implemented to enable AOP operations between CIM clients and data providers. The CIM providers comprise an Aspect Semantic Analyzer to similarly enable AOP operations comprising CIM MOF aspect and dynamic pattern extensions. As a result, cross-profile crosscutting concerns are reduced, thereby allowing dynamic changes in the CIM model and enabling just-in-time configuration changes and real-time environment adaptation.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

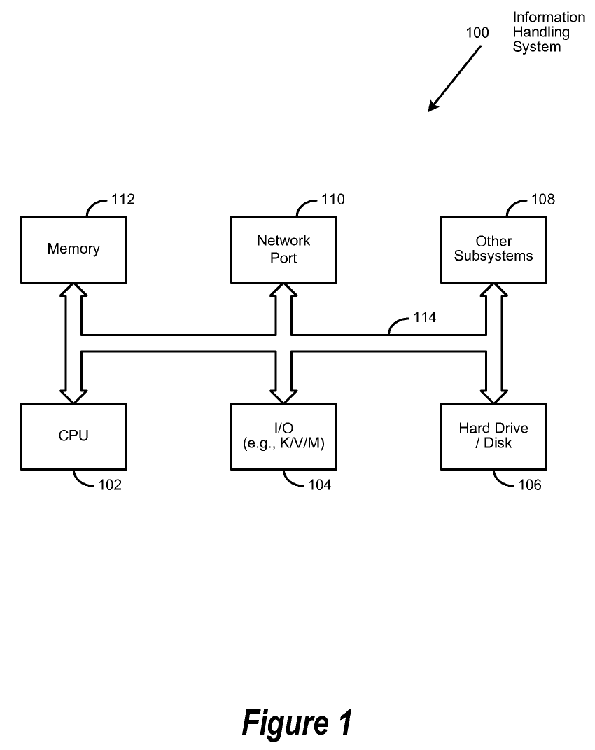

FIG. 1 is a generalized illustration of an information handling system 100 that can be used to implement the system and method of the present invention. The information handling system includes a processor (e.g., central processor unit or “CPU”) 102, input/output (I/O) devices 104, such as a display, a keyboard, a mouse, and associated controllers, a hard drive or disk storage 106, various other subsystems 108, network port 110, and system memory 112, all interconnected via one or more buses 114.

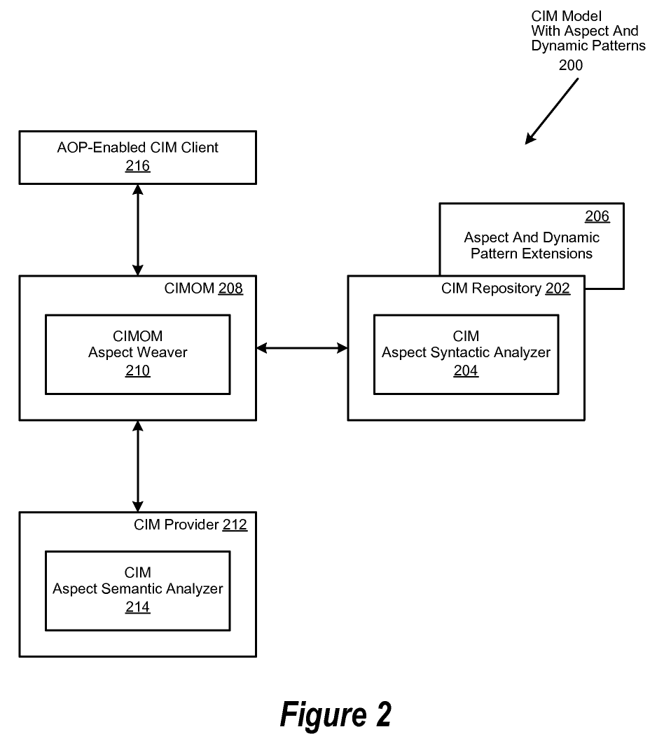

FIG. 2 is a generalized block diagram of a Common Information Model (CIM) object model 200 implemented with aspect and dynamic pattern extensions in accordance with an embodiment of the invention. In this embodiment of the invention, CIM repository 202 comprises CIM aspect syntactic analyzer 204, which extends a CIM Managed Object Format (MOF) to implement aspect and dynamic pattern extensions 202. In an embodiment of the invention, CIM MOF extensions 202 comprise an Aspect Oriented Programming (AOP) join point familiar to those of skill in the art. In one embodiment of the invention, the join point is implemented as an association class referencing two classes. In an embodiment of the invention, the two classes may reside in different CIM profiles. In another embodiment of the invention, the two classes may reside in the same profile. In a different embodiment of the invention, the join point is implemented as a method call of a first class to a property of a second class. In an embodiment of the invention, the two classes may likewise reside in different CIM profiles or the same profile.

CIM repository 202 is accessed by CIM Object Manager (CIMOM) 208, which comprises CIMOM aspect weaver 210, which is implemented to enable AOP operations between AOP-enabled CIM client 216 and CIM provider 212. CIM provider 212 comprises CIM Aspect Semantic Analyzer 214 to similarly enable AOP operations comprising CIM MOF aspect and dynamic pattern extensions 206. It will be apparent to those of skill in the art that implementation of these and other embodiments of the invention reduce cross-profile crosscutting concerns, thereby allowing the CIM object model to adapt to dynamic role, resource, or service changes such as logging, debugging, security or quality of service (QOS) in real-time.

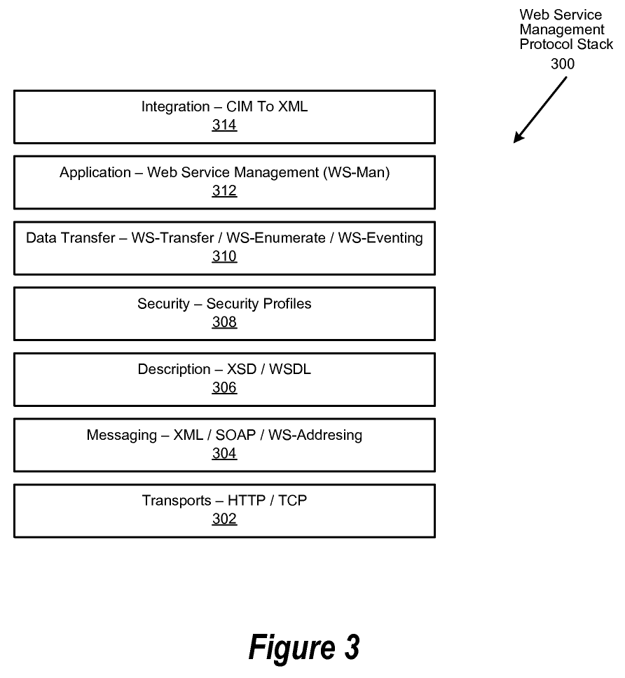

FIG. 3 is a generalized block diagram of a Web Services Management (WM-Man) protocol stack 300 as implemented in accordance with an embodiment of the invention. Block 302 depicts the transport layer, comprising Hypertext Transport Protocol (HTTP), Transmission Control Protocol (TCP), and other similar protocols. Block 304 depicts the messaging layer, comprising Extensible Mark-up Language (XML), Simple Object Access Protocol (SOAP), Web Services Addressing and other similar protocols. Block 306 depicts the description layer comprising XML Schema Definition (XSD), Web Services Description Language (WSDL), and similar protocols. Block 308 depicts the security layer, comprising a plurality of security profiles. Block 310 depicts the data transfer layer, comprising Web Services Transfer, Web Services Enumerate, Web Services Eventing, and similar Web Services data transfer operations. Block 312 depicts the application layer, comprising the Web Services Management (WS-Man) and other CIM management protocols. Block 314 depicts the integration layer, comprising CIM to XML exchanges of data for integration. In an embodiment of the invention an AOP-enabled WS-Man client is implemented to talk to a WS-Man client application comprising an aspect semantic analyzer in its provider and an aspect weaver in its listen service.

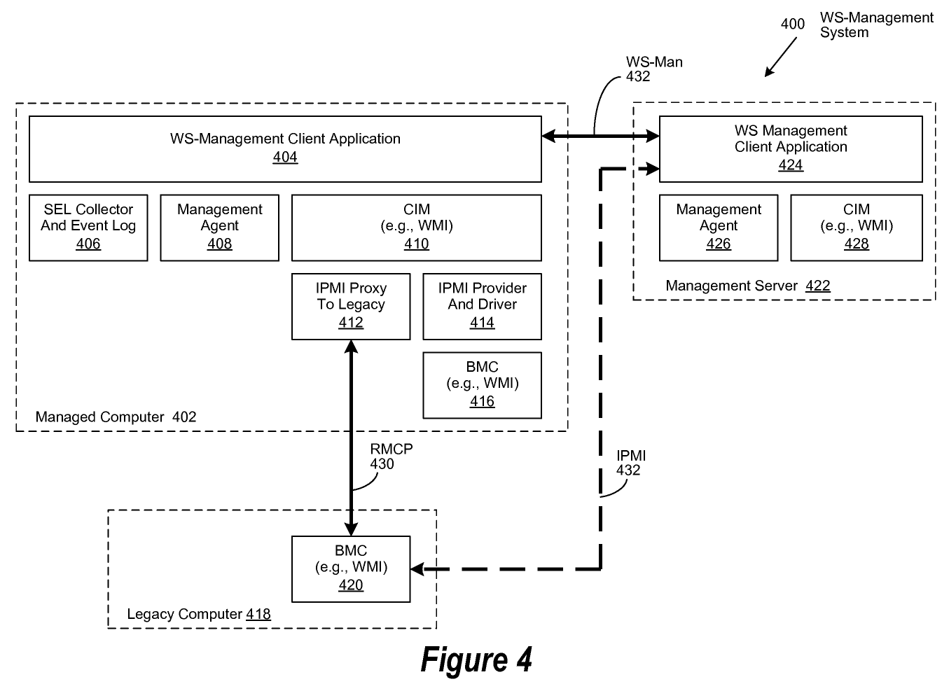

FIG. 4 is a generalized block diagram of a Web Services Management (WS-Man) system 400 as implemented with a legacy system in accordance with an embodiment of the invention. In this embodiment of the invention, managed computer 402 comprises WS-Management client application 404, System Event Log (SEL) collector and event log 406, management agent 408, and CIM object model implementation (e.g., Windows Management Instrumentation, etc.) 410. Managed computer 404 further comprises Intelligent Platform Management Interface (IPMI) proxy 412 to legacy system, IPMI data provider and driver 414, and Baseboard Management Controller (BMC) 416 implemented with a CIM protocol such as WMI. Management server 422 comprises WS-Management Client Application 424, management agent 426 and CIM object model implementation (e.g., Windows Management Instrumentation, etc.) 410. Legacy computer system 418 comprises BMC 416 implemented with a CIM protocol such as WMI.

In this embodiment, IPMI-enabled link 432 coupling management server 422 and legacy computer 418 is not available. For example IPMI may not be supported, or the IPMI link is out of service. To connect management server 422 to legacy computer 418, WS-Man-enabled link 432 is implemented to convey management information between WS-Management client application 424 comprising management server 422 and WS-Management client application 404 comprising managed computer 402. Management information is conveyed from BMC 420 comprising legacy computer 418 to IPMI proxy 412 comprising managed computer 402 via Remote Management Control Packet (RMCP) protocol. IPMI proxy 412 conveys the management information in turn to IPMI provider 414, which then provides it through WS-Man-enabled link 432 to WS-Management client application 424 comprising management server 422. In another embodiment of the invention, legacy computer 418 comprises proprietary or out-of-date system management protocols.

As described in greater detail hereinabove, WS-Man can be similarly implemented with IPMI proxy 412 to provide system management of legacy computer 418 through management server 422. Skilled practitioners in the art will recognize that many other embodiments and variations of the present invention are possible. In addition, each of the referenced components in this embodiment of the invention may be comprised of a plurality of components, each interacting with the other in a distributed environment. Furthermore, other embodiments of the invention may expand on the referenced embodiment to extend the scale and reach of the system's implementation.

What is claimed is:

1. A system for communicating information between a plurality of information handling systems, comprising:
an aspect semantic analyzer operable to implement a common information model (CIM) managed object format (MOF) comprising aspect and dynamic pattern extensions;
a CIM provider comprising said aspect semantic analyzer;
a CIM object manager (CIMOM) comprising an aspect weaver operable to use said CIM MOF extensions to:
resolve cross-profile association cross-cutting concerns, and;
enable real-time adaptation to changes in the behavior of the CIM object model, and;
an aspect oriented programming (AOP) enabled CIM management client operable to implement said CIM MOF aspect extensions.

2. The system of claim 1, wherein said CIM MOF extensions comprise a join point, comprising an association class referencing first and second classes.

3. The system of claim 1, wherein said CIM MOF extensions comprise a join point, wherein said join point comprises a method call of a first class to a property of a second class.

4. The system of claim 3, wherein said method call is operable to be filtered by a service.

5. The system of claim 1, wherein said aspect weaver comprising said CIMOM is operable to implement AOP operations with said CIM management client.

6. The system of claim 1, wherein said CIM MOF aspect and dynamic pattern extensions are implemented via an aspect syntactic analyzer.

7. The system of claim 6, wherein said aspect syntactic analyzer comprises an MOF builder.

8. The system of claim 1, wherein said AOP-enabled CIM client is implemented with the Web Services Management (WS-Man) protocol.

9. The system of claim 8, wherein said AOP-enabled CIM client implemented with said WS-Man protocol is operable to communicate with said aspect weaver comprising said CIMOM of claim 1.

10. The system of claim 8, wherein said AOP-enabled CIM client implemented with said WS-Man protocol is operable to communicate with said semantic analyzer comprising said CIM provider of claim 1.

11. A method of communicating information between a plurality of information handling systems, comprising:
using an aspect semantic analyzer in a common information model (CIM) provider to implement a CIM managed object format (MOF) comprising aspect and dynamic pattern extensions;
using said CIM object extensions in a CIM object manager (CIMOM) comprising an aspect weaver operable to:
resolve cross-profile association cross-cutting concerns, and;
enable real-time adaptation to changes in the behavior of the CIM object model, and;
using said CIM MOF aspect extensions in an aspect oriented programming (AOP) enabled CIM management client.

12. The method of claim 11, wherein said CIM MOF extensions comprise a join point, comprising an association class referencing first and second classes.

13. The method of claim 11, wherein said CIM MOF extensions comprise a join point, wherein said join point comprises a method call of a first class to a property of a second class.

14. The method of claim 13, wherein said method call is operable to be filtered by a service.

15. The method of claim 11, wherein said aspect weaver comprising said CIMOM is operable to implement AOP operations with said CIM management client.

16. The method of claim 11, wherein said CIM MOF aspect and dynamic pattern extensions are implemented via an aspect syntactic analyzer.

17. The method of claim 16, wherein said aspect syntactic analyzer comprises an MOF builder.

18. The method of claim 1, wherein said AOP-enabled CIM client is implemented with the Web Services Management (WS-Man) protocol.

19. The method of claim 18, wherein said AOP-enabled CIM client implemented with said WS-Man protocol is operable to communicate with said aspect weaver comprising said CIMOM of claim 1.

20. The method of claim 18, wherein said AOP-enabled CIM client implemented with said WS-Man protocol is operable to communicate with said semantic analyzer comprising said CIM provider of claim 1.
